(19) United States
(12) Patent Application Publication
(10) Pub. No.: US 2008/0175232 A1
(43) Pub. Date: Jul. 24, 2008

(54) SYSTEM AND METHOD FOR MULTI-SERVICE VIRTUAL NETWORKS BY INTEGRATION, CONVERGENCE, ZERO OPPORTUNITY COST, AND DISTRIBUTED USER CONTROL

(76) Inventors: Wei K. TSAI, Irvine, CA (US); Jordi Ros-Giralt, Aliso Viejo, CA (US); Albert Lee, Aliso Viejo, CA (US)

Correspondence Address: FRANK F. TIAN, 331-4A THIRD AVENUE, LONG BEACH, NJ, 07740, US

(21) Appl. No.: 12/015,792

(22) Filed: Jan. 17, 2008

Related U.S. Application Data
(60) Provisional application No. 60/885,569, filed on Jan. 18, 2007.

(51) Int. Cl. H04L 12/66

(52) U.S. Cl. 370/355

(57) ABSTRACT

a system and method is provided for multimedia multi-services over IP networks such as telephone service, SMS, MMS, video-on-demand, music-on-demand, IPTV, interactive gaming services, and etc., by exploiting unused phone lines, unused broadband access links, PSTN (Public Switched Telephone Network) switching systems, and etc.

### REFERENCE TO RELATED APPLICATIONS

This application claims an invention which was disclosed in Provisional Application No. 60/885,569, filed Jan. 18, 2007 entitled “System and Method for Multi-Service Virtual Networks by Integration, Convergence, Zero Opportunity Cost, and Distributed User Control”. The benefit under 35 USC § 119(e) of the United States provisional application is hereby claimed, and the aforementioned application is hereby incorporated herein by reference.

### FIELD OF THE INVENTION

The present invention generally relates to a system and method for multimedia multi-services, more particularly, relates to a system and method for multimedia multi-services over IP networks by exploiting unused capacities with a distributed system of switching and control.

### BACKGROUND OF THE INVENTION

For IP networks, due to their inherent network structure and fee structure, unused capacity can be advantageously used. In particular, when an IP network is used in conjunction with a PSTN network, it is desirous to utilize the unused capacity resulting from the combination of the PSTN network and the IP network.

Therefore, it is desirable to provide a system and method for providing multimedia multi-services over IP networks such as telephone service, SMS, MMS, video-on-demand, music-on-demand, IPTV, interactive gaming services, and etc., by exploiting unused phone lines, unused broadband access links, PSTN (Public Switched Telephone Network) switching systems, and etc.

### SUMMARY OF THE INVENTION

It is, therefore, an object of the present invention to provide a system and method for multimedia multi-services that exploits the ZOC capacity of unused phone lines and/or unused broadband access links.

It is another object of the present invention to provide a system and method to enable households to share unused phone lines and/or unused broadband access links.

It is another object of the present invention to provide a system and method for locating IP addresses of IP phones using a cellular switching system.

It is another object of the present invention to provide a system and method to enable two IP phones to connect to each other even though at least one of them sits behind a NAT/firewall box.

It is yet another object of the present invention to provide a system and method to provide an UMA-equivalent or IMS-equivalent service without media gateways or UMA controllers.

It is yet another object of the present invention to provide a system and method to make VoIP to VoIP, VoIP to circuit, circuit to circuit, circuit to VoIP connections without the use of the protocols of IMS, Skype, UMA, and SIP.

In accordance with one aspect of the present invention, there is provided a method to enable a household to receive VoIP phone calls while its phone line is busy.

In accordance with one aspect of the present invention, there is provided a method to enable WiFi VoIP service in a location where only WiBro/WiMax service is the only available Internet access service.

In accordance with one aspect of the present invention, there is provided a method to enable partly PSTN and partly VoIP voice connections in order to minimize the toll charges from the PSTN carriers.

In accordance with another aspect of the present invention, there is provided a method to use the phone numbers from the PSTN as public identifiers for the IP phones, and each IP phone is enabled to have a set of private identifiers.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows how MSVN makes a part-PSTN and part WiFi VoIP call.

FIG. 2 shows how MSVN provide a UMA-like handoff between cellular and WiFi VoIP.

FIG. 3 shows how the cellular switching system is used to identify the IP address and port number (control plane) for connecting VoIP calls.

FIG. 4 shows how MSVN switch phone call to lower the toll charges by routing to the least cost paths.

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The present invention is built upon several key concepts: P2P (peer-to-peer) sharing, exploitation of zero opportunity cost resources, distributed switching system, user control, and circuit-to-packet seamless handoff.

P2P sharing is a popular form of collaborative sharing of resources by individual users. The resources can be files, data, bandwidths, computing resources, storage, and etc. There exist numerous methods and protocols for P2P sharing and it is estimated that 60% of traffic today in the Internet is P2P induced. Prominent examples include grid computing, Napster, and Skype.

In the co-pending application Ser. No. 11/497,298, which is hereby incorporated herein by reference, the concept of zero opportunity cost (ZOC) resource was introduced. If a resource has been fully paid for, then the opportunity cost of not using it is zero; on the other hand, the resource could still be used to generate values for non-owners of the resource. Such a resource will be called a ZOC resource.

In fact, a large portion of P2P sharing is based on exploitation of ZOC resources, while the term ZOC is still relatively unknown. In fact, grid computing can be interpreted as a method to exploit ZOC bandwidths and ZOC computing resources, and Skype IP telephony can be interpreted as exploiting ZOC user bandwidths.

In the co-pending application Ser. No. 11/497,298, which is hereby incorporated herein by reference, the method to exploit large scale ZOC communication bandwidths and computing capacities is referred to as EPP (enterprise P2P). The present invention is, in part, a continuation of the original EPP system and method, to thereby provide multimedia multi-service over IP networks by constructing a virtual network. Such a network is called MSVN (multi-service virtual network).

A MSVN is designed as a light weight replacement to an IMS (IP multimedia subsystem) service network. IMS is a general-purpose, service delivery architecture and open industry standard for IP-based mobile and fixed multimedia services.

MSVN is differentiated from other service platforms, in particular, IMS, by the following unique feature set: (1) P2P exploitation of ZOC resources, (2) being an edge network technology, (3) being a virtual network built on top of other networks, (4) convergence of all access technologies below IP-layer, (5) integration of all applications over IP transport, (6) distributed user control of access, and (7) cross-platform customizable multi-service.

Comparing MSVN against IMS, the following can be stated:

MSVN is built entirely on the P2P sharing of ZOC resources, while IMS is built by individual carriers, with sharing of resources by having interoperability. Fundamentally, interoperability is different from P2P and the concept of exploiting ZOC capacities is missing in the IMS architecture.

Next, MSVN is an edge network technology; while IMS is a core network technology.

Next, MSVN is built as a virtual network: most of its functionalities are realized by piggybacking the functionalities of some carrier or operator networks. In contrast, an IMS network has to implement its core functionalities.

Both MSVN and IMS are all-IP network platforms. However, there is an important difference between the two: mobility support for MSVN is at layer 3 (IP layer); while mobility support for IMS is most often supported by layer 2 or MIP (mobile IP) at layer 3.

Again, both MSVN and IMS seem to be integrating all applications running over IP. However, the important difference is that MSVN is based on the break-through integration-convergence technology, C-forwarding, as specified in our co-pending patent, PCT/US2006/035630, which is hereby incorporated herein by reference. The C-forwarding technology enables any application over any transport layer over IP without any modification. In contrast, to support mobility, most applications running over IMS has to adapt (be modified) to the specific mobility support protocol suite.

The next significant difference between MSVN and IMS is that MSVN allows end users to control their own access to the networks and services. In the design philosophy of P2P, in the MSVN platform, end users own their rights to access network and network-based services; therefore, MSVN is not a “walled garden” (an environment where the user's choice of services and access rights are limited by carriers). However, IMS remains a walled garden due to the self-interest of the carriers that built the IMS infrastructure.

Finally, since MSVN is based on P2P technology, the requirements on the underlying platforms on which to build the virtual network are much smaller (more relaxed) than that of IMS. Recall that IMS is really a set of standards specifying how multimedia delivery must be done. Therefore, it is much easier to provision cross-platform and customizable new services with MSVN than with IMS.

The possible set of service offerings from an MSVN is extremely large. The intended services from the present invention mainly focus on multimedia multi-services: telephony, video, audio, messaging, collaboration, IPTV, interactive gaming, and etc.

The first area of multi-service for MSVN is that of telephony. One particular telephony service related to the present invention is that of UMA (unlicensed mobile access). UMA allows a dual mode phone (with both cellular and WiFi telephony) to make a part-WiFi and part-PSTN connection where the cellular side technology is GSM/GPRS. In a similar way, IMS allows dual mode phones to make half-cellular and half-WiFi connections where the cellular side technology can be CDMA.

Both UMA and IMS enable circuit-to-packet seamless handoff for voice connections. Both methods require packet-to-circuit switching at the boundary of PSTN. This kind of switching is necessary, if a dual mode phone switches its mode (circuit to packet and vice versa) due to mobility. For both services, the switching is done by a gateway (media gateway or UMA controller). A preferred embodiment of the present invention provides a system and method to reduce the required gateways to simple multi-purpose access points.

The exploitation of ZOC resources must come with a business model. The most usual business model is that the original owner of the resources must be allowed to use the ZOC resources unrestricted, while the non-owner users who wish to exploit ZOC resources should use the resources only when the resources were unused by the owners.

For most resources for multimedia services, the capacity can be shared in a continuous way: any numerical percentage of sharing is theoretically possible.

However, the use of 2-way phone line is limited to all-or-nothing to a single pair of users. Therefore, there exists a need to devise ZOC business model to share phone lines

Related to P2P based multimedia service is P2P switching. For example, Skype has built a P2P distributed switching system to accomplish two goals for IP telephony: directory service, and connection service.

To connect two IP phones, the switching system must be able to bind an IP address to an IP phone identity. This is similar to the DNS (domain name system) service in the Internet to associate a website name to an IP address of the site.

The connection service must provide the means to make the actual data path and control path connections between the two end IP phone terminals. While the actual connection could be initiated and executed by one of the IP phones, the execution must be enabled. For example, if one or both terminals sit behind a NAT (network address translation) box, simple knowledge of the IP addresses from both sides might not be sufficient for making the connection. This is the well-known problem of NAT traversal.

There are two kinds of NAT traversal: static and dynamic. For static NAT traversal, the problem is to make the connection given that both sides are not connected to begin with. For dynamic NAT traversal, both sides are assumed to be connected and the problem is to maintain connectivity while both sides move across different NAT boxes.

A solution to the dynamic NAT traversal problem was disclosed in our co-pending application, PCT/US2006/035630, which is hereby incorporated herein by reference. The present invention mainly concerns with static NAT traversal.

Due to the P2P nature of MSVN, the issue of voice neutrality arises. Today, net neutrality is being hotly debated for data usage over the Internet. With MSVN it is possible to re-route a phone call to a cheaper or zero-cost (sharing with another user with a flat-fee voice service) route. Whether or not a carrier will block such a call remains to be seen.

It is interesting to compare the Skype platform against MSVN. While both Skype and MSVN are both based on P2P ZOC design, the fundamental difference is that Skype only leverages on packet switching bandwidths; but MSVN leverage on all kinds of bandwidths: circuit switching bandwidths, server computing power, and most important of all, the computing power in the almost ubiquitous WiFi access points.

A second critical difference is that P/C (packet to circuit) and C/P (circuit to packet) switching are done in the access points with a DSL/POTS line to the PSTN. For Skype, the switching is aggregated at specific media gateways at the boundary of a PSTN. In this case, Skype has to pay PSTN carriers to gain the access rights to the PSTN. This is a carrier to carrier business arrangement: recall that Skype is a virtual carrier.

For MSVN, there will be no payment made to PSTN carriers from the MVSN carrier. The payments have been made by individual subscribers; the MSVN carrier is simply exploiting the ZOC phone subscriptions from the PSTN carrier.

The third but not the least difference is that Skype is a proprietary service platform. Any new services, such as push-to-view and push-to-talk over heterogeneous networks require wholesale addition to the Skype functionalities. As for MSVN, several choices are possible: (1) users can bundle different applications through the use of convergence technology developed in the co-pending application, PCT/US2006/035630, which is hereby incorporated herein by reference. (2) the MSVN carrier can bundle the difference applications and services and offer to user as a package, again through the software convergence technology in the co-pending application.

The present invention is a broad system and method for exploiting ZOC capacities for multimedia multi-services. A preferred embodiment of the components of the architecture include: (1) switching system, (2) mobility support, (3) service provisioning system, (4) admission control, (5) ZOC monitoring system, (6) ZOC allocation system, (7) billing and monitoring system.

The seven components cited above can be implemented using software, and software insertion into commercial off-the-shelf terminal devices and boxes.

A unique feature of MSVN is that, due to complete flexibility in exploiting ZOC capacities, MSVN is even able to use the infrastructure of any IMS, Skype, PSTN, and other service providers as generalized ZOC capacities.

According to a preferred embodiment of the present invention, the switching system conducts two services: directory service and connection service.

According to a preferred embodiment of the present invention, the directory service binds a private identifier to a publicly reachable IP adport (a two-tuple consisting of an IP address and a port number). A private identifier can be in the form of private IP address, private identifier agreed between two parties, or private identifier provided by an MSVN carrier.

According to a preferred embodiment of the present invention, the directory service piggybacks on carriers' or operators' switching systems. For example, in the case of dual mode phones with both cellular interface and WiFi interface, the following piggybacked switching can be implemented in an MSVN.

The two dual mode phones first makes a connection between them using the cellular switching system. Assume that both phones are in a WiFi zone with WiFi access to the Internet. Once the connection has been made, both phones send their respective publicly reachable adports to each other via the short message service from the cellular carrier.

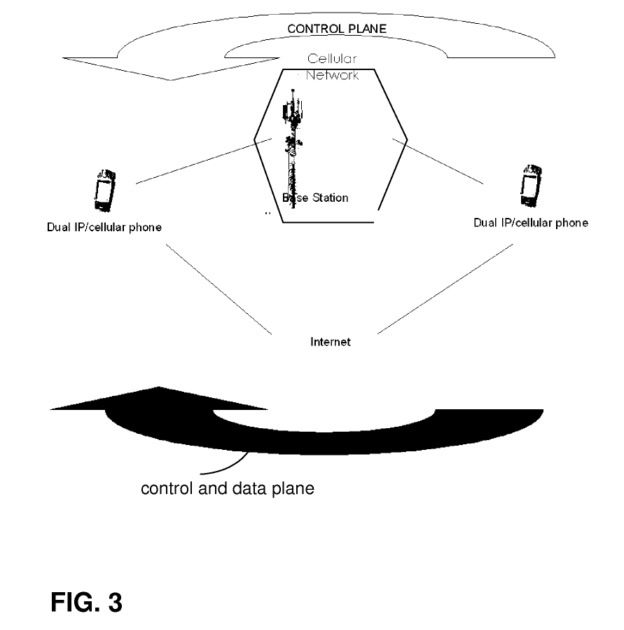

Once both dual mode phones receive the respective publicly reachable IP adports, then they can do an end-to-end circuit to packet soft handoff and the cellular connection is consequently transferred to the IP connection through WiFi. The end-to-end circuit to packet soft handoff is disclosed in more detailed in a PCT application titled “End-to-End Architecture for Universal Mobility and Wireless-Aware Transport,” which is hereby incorporated herein by reference and is depicted in FIG. 3.

A preferred embodiment to discover publicly reachable IP adports is implemented as follows. In this embodiment, each dual mode phone is associated with an access point with a public IP address. Whenever a dual mode phone is active and the dual mode phone has WiFi access to the Internet, the access point associated with a dual mode phone will send dummy packets, on a regular basis, to the dual mode phone to open a hole on the NAT box if any that hides the dual mode phone. This sending of dummy packets is triggered by a dual mode phone sending a register message to the fixed associated access point. This method of NAT traversal is specified in a co-pending provisional application, 60/864,517 which is hereby incorporated herein by reference.

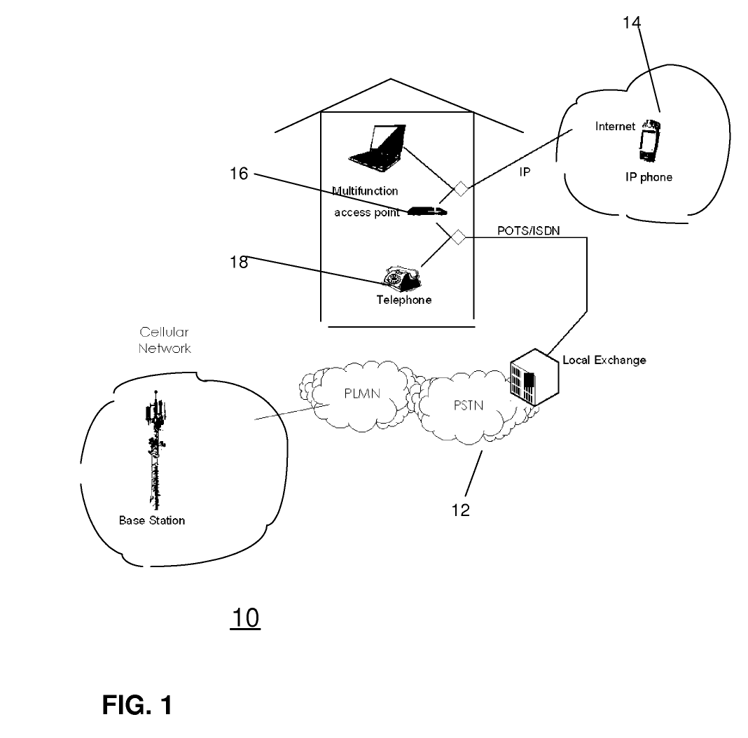

Another preferred embodiment 10 of the present invention provides a simple P/C (packet to circuit) switching at an access point to the PSTN 12. In this embodiment, a dual mode phone 14 is once again associated with a fixed access point 16. This access point is assumed to have access to both the Internet and a PSTN local exchange, and is assumed to be publicly reachable. If the dual mode phone 14 is in a WiFi zone with access to the Internet and wishes to call a PSTN phone, then the dual mode phone 14 will send a signal to the fixed access point 16 to start the process. The fixed access point 16 will initiate the PSTN signaling to connect to the PSTN phone 18 as a proxy. Once connected, the access point 16 will establish two connections piecing together: one connection is from the access point 16 to the PSTN phone through the PSTN access interface, and the VoIP connection between the access point 16 and the calling dual mode phone 14. In essence, the access point 16 acts as a media gateway for P/C switching for the calling dual mode phone 14 and the called PSTN phone 18. This case is depicted in FIG. 1.

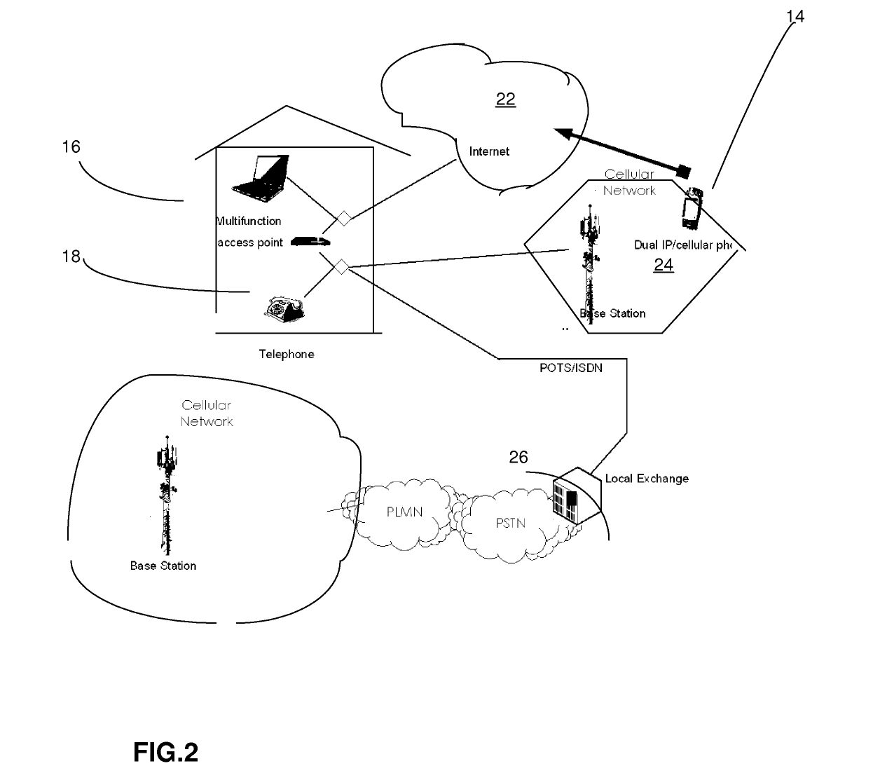

In another preferred embodiment 20 of the present invention performs a UMA-like P/C or C/P roaming. In this scenario, a dual mode phone 14 is assumed to be in a circuit conversation with another PSTN phone 18. Assume that the dual mode phone 14 now moves into a WiFi zone and wishes to switch part of the connection to WiFi. The dual mode phone 14 will send a handoff request to the access point 16 for a circuit to packet soft handoff. Then the dual mode phone 14 sets up a VoIP connection between itself and the access point 16 via either Internet 22 or a cellular network base station 24. Then the dual mode phone 14 conducts a circuit to packet soft handoff on the terminal itself. At the same time, the access point 16 does a packet-to-circuit switching: converting the VoIP packets from the dual mode phone into circuit data frames. This scenario is depicted in FIG. 2.

For this mobility to work, the access point 16 must be on the path of the original circuit call. This is accomplished by a preferred embodiment of the present invention wherein, all circuit calls of a dual mode phone 14 are constrained to go through a specific box 26. A requirement is that this box must have access both to the public Internet and PSTN. This box can either be fixed forever or be known to the dual mode phone 14 before the circuit call is established. A necessary condition is that this box 26 must be reachable through the public IP network from the dual mode phone 14. In a preferred embodiment, this box 26 is the home access point with both DSL/POTS line; in another preferred embodiment, the box 26 can be any ZOC box with the required network interfaces and reachability.

In yet another preferred embodiment, there is one WiFi IP phone that roams in a WiFi zone wishing to make a connection to a PSTN/PLMN phone. In this case, the IP phone makes a VoIP connection to a fixed access point. The access point must have access to both the public Internet and PSTN. Upon receiving a request to make the call from the IP phone, the access point will set up two connections: one VoIP connection from the IP phone to the access point and another circuit call from the access point to the called PSTN/PLMN phone. Further, once the calls have been set up, the access point will act as packet-to-circuit switch: translating VoIP packets into circuit frames and vice versa. This situation is also depicted in FIG. 1.

In yet another preferred embodiment, an access point is equipped with both WiBro and WiFi interfaces. In this embodiment, multiple VoIP connections through the WiFi interface can be vertically connected to a single WiBro connection through the multipath packet deliver technology in a co-pending provisional application, 60/864,513, which is hereby incorporated herein by reference.

In yet another preferred embodiment, the fixed access point that associated with a dual mode phone is associated with a plurality of access points with similar equipment and network interfaces. In this embodiment, the access points associated a dual mode phone are utilized by a fixed policy. If an access point is busy, for example, its PSTN line is busy and the request is to connect through that busy line, then the next access point is to be chosen for the purpose. In another example, if the request is make a VoIP connection to another IP phone, and the currently chosen access point has a poor QoS or low bandwidth for the Internet access, then the next access point is to be chosen.

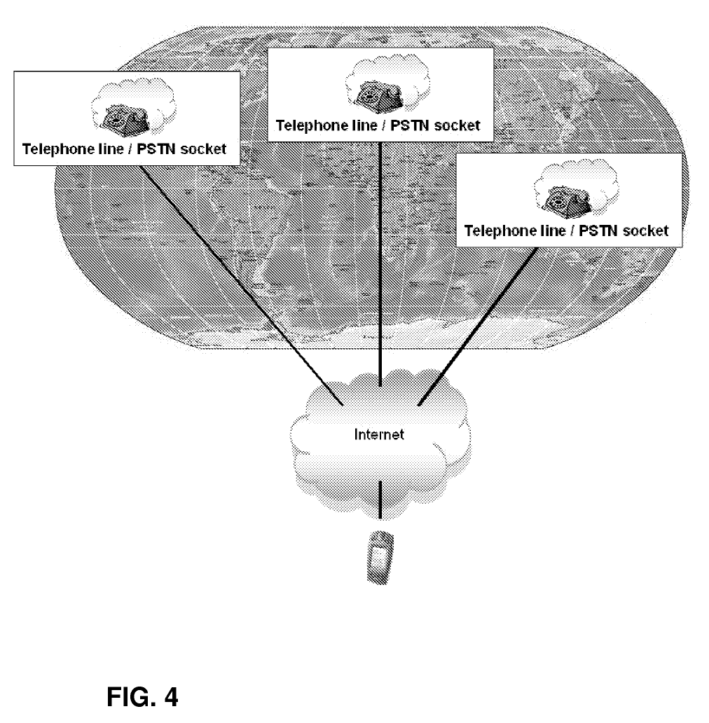

In yet another preferred embodiment, a voice connection is broken down into PSTN parts and VoIP parts. Each connection might have multiple VoIP parts and multiple PSTN parts. The PSTN parts are chosen such a way to minimize total toll charges. In one embodiment, as one dual mode phone calls a PSTN number in Spain from outside Spain, the minimal cost set up is make a VoIP connection to an access point with both WiFi-Internet, and PSTN interfaces, inside Spain. The second leg of this connection is to be set up the access point through the PSTN interface to the called Spain PSTN phone. In Spain, a large portion of Spain's PSTN phone pays a flat fee for all phone calls within Spain. In this manner, there is no additional toll charge for the long-distance voice connection from an overseas dual mode phone to Spain PSTN phone. This case is illustrated in FIG. 4.

In yet another preferred embodiment, access points with both PSTN interface and WiFi-Internet interface are utilized in the ZOC P2P sharing scheme. These sets of APs communicate with a group of controlling APs that monitor the availability of both PSTN lines and Internet bandwidths. Each dual mode phone that is a subscriber of MSVN service is given the right to use some ZOC bandwidths (PSTN or IP) through an admission control system and ZOC resource allocation system. The allocation is based on the QoS of the allocated connection and the cost of the allocated connection, for example, toll charges to PSTN use. A detailed design for video streaming is disclosed in the application, PCT/US2006/035630 which is hereby incorporated herein by reference.

In yet another preferred embodiment, the following methods are used to compensate the original owner of a PSTN line which is being used as a ZOC resource by a non-owner:
(1) Instant termination of the ZOC use: the ZOC connection is terminated the moment the owner indicates his wish to use. To smooth out transition, a ring tone will be provided to the new connection before the old connection is torn down.
(2) The ZOC connection is switched to another part-circuit part-packet (including purely circuit or purely packet connections as special cases) connection.
(3) If the new connection is a dual mode phone call from outside, the ZOC connection retains its use, and the owner is connected to the calling dual mode phone through a VoIP connection.

In yet another preferred embodiment, a single phone number is shared between by a plurality of IP phones. The single phone number only identifies the unique access point that is equipped with the interface to the PSTN phone line. When such an IP phone is in a conversation with an outside PSTN phone, the identity of the IP phone will be the unique single phone number. In all other cases, a unique identity of the IP phone will be used.

In all the above embodiments, there is no need for SIP, Skype, IMS, or UMA to accomplished the needed tasks.

According to a preferred embodiment, the MSVN framework is designed to provision an all-IP infrastructure to support collaboration among distributed heterogeneous (wired and wireless) clients. The framework uses the current state (resources, capabilities and limitations) of the system/network, and the current interests of the client, to construct a client profile. This profile is used in conjunction with a policy driven inference engine to manage and adapt application QoS. Adaptation policies as well as mechanisms are programmable.

According to a preferred embodiment, the MSVN platform is possible by leveraging push-to-talk over cellular (PoC) standards. PoC enables real time instant messaging across the heterogeneous cellular access technologies and handsets.

Other killer applications over MSVN would be collaborative any-to-any multimedia applications that go beyond voice. MSVN can be enabled to provision ICCS: (Instant collaboration and Content Sharing) service which meets the customer's demand of a level of sophistication from mobile data services and offers widespread service innovation across a broad base of multimedia content.

For example, multimedia applications combining voice, text, pictures and images can even be envisaged. Anywhere somebody can benefit from having and being able to comment on a visual depiction of a situation or matter, such collaborative is desired and can be useful.

According to a preferred embodiment of MSVN is a multi-service platform offering a single point from which to develop, deploy, manage and bill for interactive person-to-person and group/community type services across heterogeneous networks.

According to a preferred embodiment, the service enabling platform consist of the following components
MSVN gateway
MSVN Session management server,
Group and List Management server
Presence Management Server
Publish/Search/Transfer Server
Thin-client enabled handset device
   Further, all the above components are realized in software and inserted into appropriate boxes.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for multimedia multi-services over IP networks comprising:
means for exploiting a capacity of unused phone lines; and
means for exploiting a capacity unused broadband access links.

2. The system of claim 1 further comprising means for locating IP addresses of IP phones using a cellular switching system.

3. The system of claim 1 further comprising means for having at least two IP phones to connect to each other even though at least one of them sits behind a NAT/firewall box

4. The system of claim 1 further comprising means for providing an UMA-equivalent or IMS-equivalent service free from media gateways or UMA controllers.

5. The system of claim 1 further comprising means for making VoIP to VoIP, VoIP to circuit, circuit to circuit, or circuit to VoIP connections free from using protocols of IMS, Skype, UMA, or SIP.

6. The system of claim 1 further comprising means for a household to receive VoIP phone calls while its phone line is busy.

7. The system of claim 1 further comprising means for enabling WiFi VoIP service in a location wherein only WiBro/WiMax service is the only available Internet access service.

8. The system of claim 1 further comprising means for providing a method to enable partly PSTN and partly VoIP voice connections in order to minimize the toll charges from PSTN carriers.

9. The system of claim 1 further comprising means for providing a method to use the phone numbers from the PSTN as public identifiers for the IP phones, wherein each IP phone is enabled to have a set of private identifiers.

10. The system of claim 1, wherein the capacity comprises a ZOC capacity
